(19) United States
(12) Patent Application Publication
(10) Pub. No.: US 2017/0308517 A1
(43) Pub. Date: Oct. 26, 2017

(54) AUTOMATIC GENERATION OF TEMPLATES FOR PARSING ELECTRONIC DOCUMENTS

(71) Applicant: Google Inc., Mountain View, CA (US)

(72) Inventors: Vanja Josifovski, Los Gatos, CA (US); Srinidhi Viswanatha, Bangalore (IN)

(73) Assignee: Google Inc., Mountain View, CA (US)

(21) Appl. No.: 14/024,147

(22) Filed: Sep. 11, 2013

(51) Int. Cl. G06F 17/24

(52) U.S. Cl. CPC G06F 17/248

(57) ABSTRACT

Methods, systems, and apparatus, including computer programs encoded on a computer storage medium, for receiving a plurality of electronic documents, each electronic document being associated with an identifier that is associated with a source of the electronic document, grouping electronic documents of the plurality of electronic documents into a plurality of base sub-groups based on respective sources, for each base sub-group of the plurality of base sub-groups, automatically processing electronic documents to provide one or more templates, each template mapping content to one or more markers, and storing the one or more templates in memory, each template being accessible by one or more parsers to parse content from subsequently received electronic documents.

### BACKGROUND

This specification relates to the automatic generation of templates for parsing information from electronic documents.

Conventional online travel booking sites allow users to identify and purchase travel according to a specified itinerary. For example, a user can purchase an airline flight itinerary for a flight departing from one location on a particular date and arriving at another location. Typically, following the purchase of a particular flight itinerary, the online travel booking site sends an electronic confirmation e-mail to the user that includes the purchased itinerary.

Conventional electronic calendars allow users to schedule events with respect to particular dates and times. Typically, a user creates a calendar entry that includes at least a date of the event and optionally includes additional information, e.g., a time span or a description of the event.

### SUMMARY

In general, this document describes technologies relating to the generation of templates for parsing information from electronic documents.

More particularly, innovative aspects of the subject matter described in this specification can be embodied in methods that include actions of receiving a plurality of electronic documents, each electronic document being associated with an identifier that is associated with a source of the electronic document, grouping electronic documents of the plurality of electronic documents into a plurality of base sub-groups based on respective sources, for each base sub-group of the plurality of base sub-groups, automatically processing electronic documents to provide one or more templates, each template mapping content to one or more markers, and storing the one or more templates in memory, each template being accessible by one or more parsers to parse content from subsequently received electronic documents. Other implementations of this aspect include corresponding systems, apparatus, and computer programs, configured to perform the actions of the methods, encoded on computer storage devices.

These and other implementations can each optionally include one or more of the following features: automatically processing electronic documents to provide one or more templates includes identifying a first character string within a first electronic document of the plurality of electronic documents, identifying a second character string within a second electronic document of the plurality of electronic documents, aligning the first character string and second character string, comparing the first character string to the second character string, identifying, based on the comparing, at least one of a shared substring section including a sequence a characters that are substantially similar between the first character string and the second character string, and a difference substring including a sequence of characters that are substantially different between the first character string and the second character string, identifying one of the markers to represent information provided by the electronic document at a location of the difference substring, providing the marker and the location of the difference substring as the template, and associating the template with one or more of the plurality of base sub-groups; one or more of the markers represents a line item include at least one sub-marker; one or more of the markers represents a plurality of line items; actions further include determining a quantity of line items in the plurality of line items, determining that the quantity satisfies at least one predetermined threshold, and associating the plurality of line items with a marker to represent the plurality of line items; the predetermined threshold is based on an expected average number of line items in an electronic document; the identifier is a network domain name for a sender of the associated electronic document, and the grouping is determined at least in part according to a hierarchy of the network domain name; the identifier includes text of the associated electronic document, and the grouping is determined at least in part based on the text; the text includes text provided in a subject description of the associated electronic document; the text includes text provided in a body of the associated electronic document; and the plurality of electronic documents are electronic mail messages, and the identifier is an electronic mail address of a sender of the associated electronic mail message, the electronic mail address having a local part and a domain part.

The systems and techniques described here may provide one or more of the following advantages. In some examples, parsing of electronic documents to provide data records enables users to be notified about content of electronic documents, e.g., at an appropriate time, place, device. In some examples, automatic parsing of electronic documents provides scalability, maintainability, and discovery. For example, instead of relying on manual acquisition of electronic documents and creation of templates, automatic parsing enables templates to be quickly and efficiently provided for a significant number of electronic documents, e.g., across varying languages. In some examples, creators of the electronic documents might change the format of an electronic document. Automatic parsing of electronic documents efficiently handles such changes, and new formats of electronic documents can be absorbed as soon they appear. In some examples, automatic parsing enables frequencies of different types of electronic documents in a corpus of electronic documents to be determined, and templates for electronic documents having a significant presence within the corpus can be provided.

The details of one or more implementations are set forth in the accompanying drawings and the description below. Other features and advantages will be apparent from the description and drawings, and from the claims.

### DESCRIPTION OF DRAWINGS

FIG. 1 is a schematic diagram that shows an example of a system for the automatic generation of templates for parsing information from electronic documents.

FIG. 2 is a block diagram that shows an example of a system for the classification of electronic documents for the automatic generation of templates.

FIGS. 3A and 3B show examples of electronic documents that may be parsed for the automatic generation of templates.

FIG. 4 shows a conceptual example of an automatically generated template for parson information from electronic documents.

FIG. 5 depicts an example use case for data records provided in accordance with implementations of the present disclosure.

FIG. 6 is a flow diagram of an example of a process that can be executed for the automatic generation of templates for parsing information from electronic documents.

### DETAILED DESCRIPTION

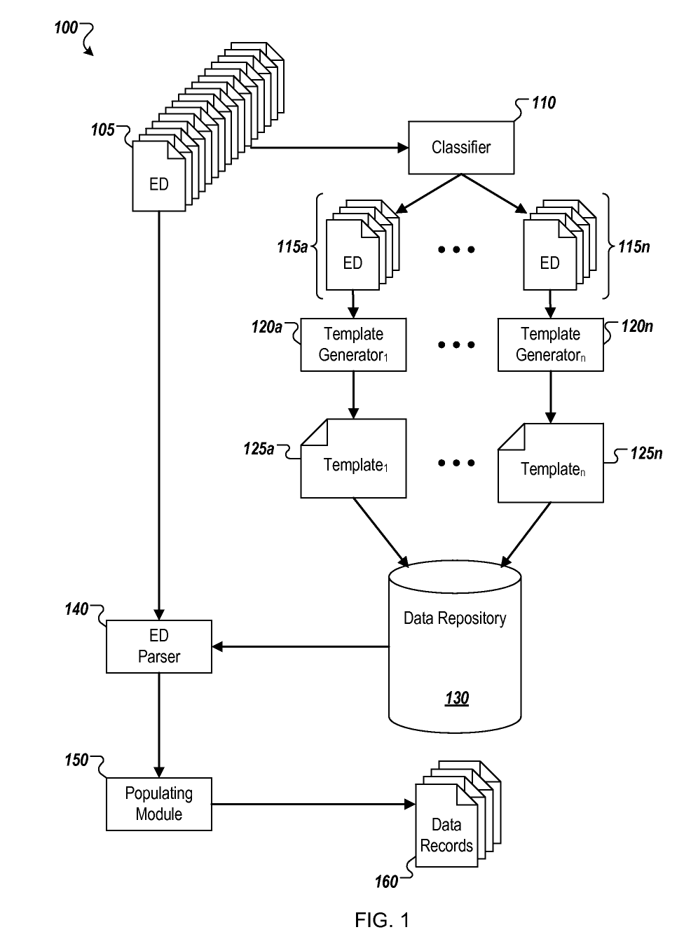

FIG. 1 is a schematic diagram that shows an example of a system 100 for the automatic generation of templates for parsing information from electronic documents. The system 100 receives a collection of electronic documents 105. In some examples, the plurality of electronic documents include electronic documents distributed using a computer-implemented service. The electronic documents 105 can be any appropriate form of electronic document or message, such as electronic mail messages (emails), “instant” messages, hypertext (HTML) documents, extensible markup language (XML) files, word processing documents, social networking posts, short messaging system (SMS) messages, multimedia system (MMS) messages, and portable document format files.

In some implementations, the electronic documents 105 can be messages sent from one or more server devices (not shown) to one or more users. For example, the electronic documents 105 can be order confirmations (e.g., receipts), order tracking updates, event booking confirmations and updates, electronic tickets, meeting requests and updates, and any other appropriate form of electronic notification or update. In other examples, the electronic documents can be alerts such as weather alert emails, financial transaction notifications (e.g., direct deposit confirmations, unusual credit card activity alerts, e-bill arrival reminders), activity alerts (e.g., security system alerts, school attendance alerts), flight tracking updates, online auction updates, or any other appropriate form or message that can convey an alert, alarm, update, or notification.

The electronic documents 105 are processed by a classifier 110. The classifier 110 groups the electronic documents 105 into collections of similar documents 115a-115n. In some implementations, the classifier 110 can group the electronic documents 105 based at least partly on the content of the documents. For example, some of the electronic documents 105 may be emails with a subject line of “Booking confirmation for XYZ Airlines” and others may be emails with a subject line of “Account Activity”. The classifier 110 may be configured to add the former documents to the collection 115a, and add the latter documents to the collection 115n. In another example, content provided in the body of the electronic documents 105 may be processed to classify and group the electronic documents 105 into the collections 115a-115n. In some examples, the electronic documents 105 can be grouped based on longest common sub-string (LCS) analysis or other comparison techniques.

In some implementations, the classifier 110 can group the electronic documents 105 based at least partly on respective sources of the electronic documents 105. In some examples, the electronic documents can be grouped based on identifiers associated with the documents. In some examples, an identifier is associated with a source of a respective document, e.g., sender, author. In some examples, an identifier can be unique to the source. Example identifiers can include electronic message address, sender name, and/or origin network address. For example, some of the electronic documents 105 may have originated from the “vendor_a.com” network domain, while others may have originated from the “vendor_b.com” network domain. In such examples, the classifier 110 may group the “vendor_a.com” documents into the collection 115a, and group the “vendor_b.com” documents into the collection 115n.

In some implementations, the collections of electronic documents 115a-115n may be arranged into sub-collections based on one or more differentiating traits, such as a collection of sub-identifiers. For example, the collection 115a may include the electronic documents 105 that have been sent from “vendor_a.com”. The classifier 110 may further subdivide the collection 115a into a sub-collection of electronic documents 105 that have been sent from an “orders@vendor_a.com” address, and a collection of electronic documents 105 that have been sent from a “customer_care@vendor_a.com” address.

The system 100 includes a collection of template generators 120a-120n. Each of the template generators 120a-120n processes a corresponding one of the collections 115a-115n to determine a collection of templates 125a-125n. For example, the template generator 120a can process the electronic documents 105 in the collection 115a to identify portions of the documents 105 that are substantially similar and identify portions of the documents 105 that are substantially different. In some examples, similarities and/or differences between the electronic documents 105 can be provided based on a comparison routine. An example comparison routine can include longest common sub-string analysis and/or a difference utility, e.g., “diff.”

In some implementations, document portions that are substantially similar across the collection of documents 115a may be identified as having static content (e.g., form text, structural elements, “boilerplate”) while document portions that differ across the collection of documents 115a may be identified as having dynamic content. In some implementations, the dynamic content may be determined to include information that is unique to a particular message for a particular user. For example, a hotel reservation confirmation email may include the name and address of the hotel as static content, and include the customer's name, the date of the reservation, and the room type as dynamic content.

In some implementations, static content may be used to help identify dynamic content. Continuing the previous hotel reservation email example, the confirmation email may include text such as “Your reservation number is: XYZ123”, in which “Your reservation number:” may be identified as static content and “XYZ123” may be identified as dynamic content. In such examples, the template generator 120a may analyze the static content “Your reservation number is:” to infer that the dynamic content “XYZ123” may be a reservation number based at least partly on the information determined from static content and the proximity of the dynamic content to the static content.

In some implementations, the template generators 120a-120n can analyze structural information and/or metadata included in the electronic documents 105 to form the templates 125a-125n. In some examples, structure-based templates can be defined based on comparing structure and content between documents. In some examples, each document can include a structure. An example structure can include a node-based structure including a hierarchy of nodes, e.g., from root node to leaf nodes, and edges between nodes. In some examples, a subject-based template can be provided based on comparing node position, e.g., within the hierarchy, and node content between electronic documents.

For example, the electronic documents 105 in one of the collections 115a-115n may be HTML-based order confirmation emails, in which the order details are presented in an HTML table. The corresponding one of the template generators 120a-120n may identify the HTML <table> and <\table> tags as being common among all the documents 105 in the collection. The corresponding template generator may also determine that the common table includes a variable number of similarly-structure rows denoted by HTML <tr> and <\tr> tag pairs, in which each row includes similarly structured variable information (e.g., quantity, price, item name) that can be extracted to identify a variable number of line items in the recipient's order. Similar techniques may be applied to other structures, such as XML based documents, character-separated files, tag-delimited files (e.g., “cost=$6.00”), or any other appropriate document structuring or layout technique.

The templates 125a-125n are stored by a data repository 130. In some implementations, the data repository 130 can be a collection of one or more electronic files, one or more tables in one or more databases, one or more flat file systems, or any other appropriate form of data storage.

Subsequently provided ones of the electronic documents 105 can be processed by an electronic document parser 140. In some implementations, subsequently received ones of the electronic documents 105 can be used to generate one or more data records 160 based on the templates 125a-125n. In some examples, one of the electronic documents 105 can be received and can be processed by the electronic document parser 140 to determine a base sub-group that the electronic document 105 could be assigned to. One or more of the templates 125a-125n associated with the base sub-group can be retrieved by the electronic document parser 140 to process the electronic document 105.

Information obtained from the electronic documents 105 by the electronic document parser 140 is provided to a populating module 150. The populating module 150 populates fields of data in one or more data records 160. In some examples, the data of one of the electronic documents 105 may be extracted in association with a data field of a corresponding one of the templates 125a-125n, and the populating module 150 can map data fields of one or more of the templates 125a-125n to data fields of the corresponding data record 160. In this manner, fields of the data record 160 can be populated with content provided in the electronic document 105.

In some implementations, the data records 160 can be provided to a user, or can be used to trigger further operations. For example, a user may have a room reserved at the “Ritzy Hotel” with a check-in time of 4 pm. An email may arrive in the user's email inbox to notify the user that he can now check in as early as 2 pm. The updated check-in information may be parsed from the email using one of the templates 125a-125n to create or update one of the data records 160 corresponding to the user's reservation. The system 100 may then, for example, use the information in the data record 160 to automatically update the user's calendar, and/or to deliver an alert to the user to notify him about the updated check-in opportunity.

In some implementations, each of the templates 125a-125n can be verified for accuracy. In some examples, accuracy of the templates 125a-125n can be determined based on one or more metrics. For example, the template 125n can be used to generate one or more of the data records 160 based on one or more of the electronic documents 105, and one or more metrics can be provided based on the generated data records 160. An example metric can include an average number of entities provided in data records 160 that are populated based on a subject template.

In the example context of electronic documents 105 associated with product purchases, an example metric can include the average number of products provided in the data records 160 provided based on the subject template. In this example context, it can be determined that an average number of products identified in the underlying electronic documents, e.g., the electronic documents 105 that the template 125b was provided from, is X products per electronic document 105, e.g., 2.1 products per electronic document 105 in the collection 120b. That is, for the collection of electronic documents 120b, it may be determined that an average of X products are identified in each electronic document 105 included in the collection 120b.

Continuing with this example context, a template that is generated based on one of the collections 120a-120n can be used to generate data records 160 for the electronic documents 105 of the corresponding collection. For example, the template maps data of the electronic document 105 to respective fields of the data record 106. In some examples, the template can be used to populate data fields of a data record 160 with data from an electronic document 105. For example, a user can receive an electronic document that corresponds to the electronic documents 105, and the template can be used to provide a data record of the electronic document for the user. In some examples, the data records can be indexed and stored, e.g., in a data repository. In this manner, data records can be retrieved in response to user requests. For example, a user can submit a query, e.g., a search query, it can be determined that one or more data records are responsive to the query, e.g., based on one or more indices, and the one or more data records can be surface to the user, e.g., in search results.

In some implementations, where data records are to be generated based on electronic documents received by a user, and/or based on user information, e.g., information about a user's social network, social actions or activities, profession, a user's preferences, or a user's current location, users are given an opportunity to control whether data records can be generated and/or user information can be used. In some implementations, users are given the opportunity to control whether data records are generated and/or whether user information is collected and/or used. In addition, certain data may be treated in one or more ways before it is stored or used, so that personally identifiable information is removed. For example, a user's identity is treated so that no personally identifiable information can be determined for the user, or a user's geographic location is generalized so that a particular location of a user cannot be determined.

Referring again to FIG. 1, and in some implementations, the data records 160 can be reviewed to determine the average number of products provided in the data records 160. In some examples, the average number of products provided in the data records 160 can be compared to the known average number of products provided in the electronic documents 105 in the collection 120a-120n corresponding to the data record 160. In some examples, if the average number of products provided in the data records 160 is within a threshold range of the known average number of products provided in the corresponding electronic documents 105, e.g., the values are the same, the values differ by less than a threshold percentage, then the template is determined to be accurate. If the average number of products provided in the data records 160 is outside of the threshold range of the known average number of products provided in the corresponding electronic documents 105, e.g., the values are different, the values differ by greater than the threshold percentage, then the template is determined to be inaccurate. In some examples, if the template is determined to be inaccurate, then the template can be modified or the template can be discarded and a new template can be generated, as discussed herein.

In general, and in view of the discussion above, implementations of the present disclosure are generally directed to generating data records based on parsing user content. More particularly, implementations of the present disclosure are directed to automatically generating templates based on a plurality of electronic documents, each template being usable with a parser to generate data records.

In one general example, an online retailer may use a template for the creation of uniform-looking email purchase receipts that may be sent out in response to customer purchases. Over time, the retailer may send many such receipts out to customers, with each receipt including content that is substantially common among the emails, such as the retailer's name, the email address used to send the email, and/or the underlying structure or layout of the email (e.g., the vendor's name may typically be found near the top and legal content may typically be found as ‘fine print’ near the bottom). Each receipt may also include content that varies among the receipts, such as order tracking numbers and/or names, prices, and quantities of items purchased.

Still speaking generally, systems that have access to many such emails, e.g., an email server, could be configured to automatically reverse-engineer templates by analyzing collections of similar documents or emails. In use, such templates could then be used to identify and extract content from similar, subsequently received documents. In some examples, the extracted information may be provided to the recipients of the documents, e.g., as order tracking update alerts. Similar techniques could also be used to process other types of electronic documents that provide information about upcoming events, orders, bookings, travel plans, meetings, schedules, or any other appropriate form of information that can be extracted from electronic documents.

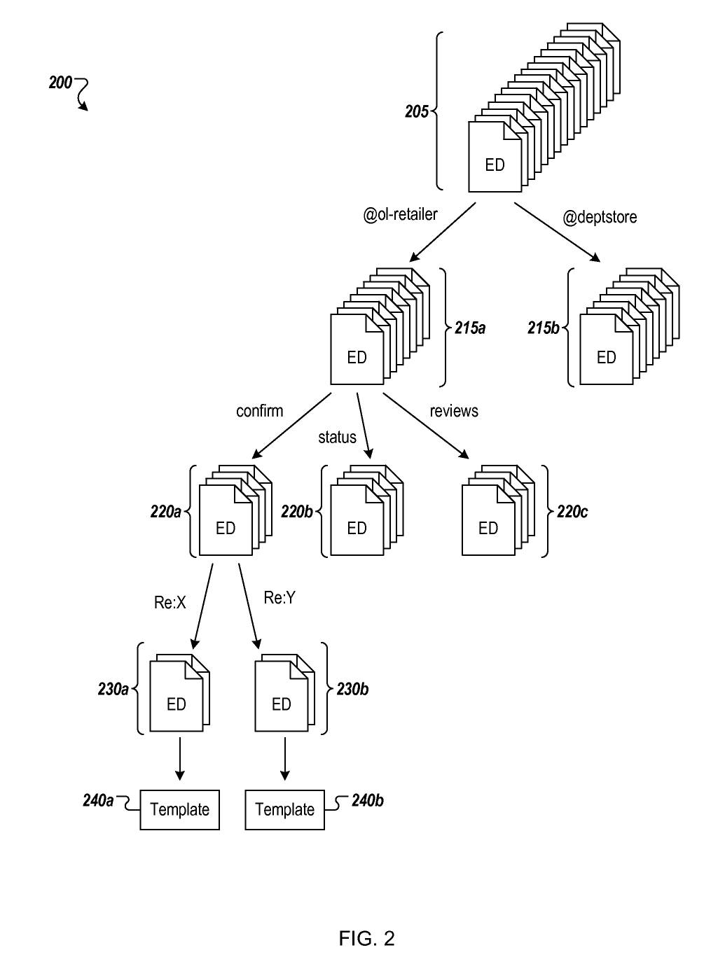

FIG. 2 is a block diagram that shows an example of a system 200 for the classification of electronic documents for the automatic generation of templates. A mentioned previously, a collection of electronic documents 205 can be classified into one or more groups and subgroups. In some implementations, the electronic documents 205 can be the electronic documents 105 of FIG. 1. Implementations of the present disclosure will be discussed in the example context of electronic messages sent from retailers, e.g., online retailers, brick-and-mortar retailers. For purposes of illustration, example retailers can be referenced as an online retailer (ol-retailer) and a brick-and-mortar retailer (dept-store). It is appreciated, however, that implementations of the present disclosure can be applied in other example contexts.

In the example of the system 200, the collection of electronic documents 205 includes electronic message (e.g., emails) originating from both the online retailer having an “@ol-retailer” network domain name, and documents originating from the brick-and-mortar retailer having an “@deptstore” network domain name. In the present example, the electronic documents 205 originate from several email accounts, e.g., identifiers, for the online retailers which can include: confirm@ol-retailer, status@ol-retailer, news@ol-retailer, and reviews@ol-retailer. Example electronic documents 205 for the brick-and-mortar retailer can include: order-conf@deptstore, order-status@deptstore, alerts@deptstore, and review@deptstore.

The documents 205 from “@ol-retailer” are grouped by a classifier (not shown), e.g., the classifier 110 of FIG. 1, into a base group or collection 215a based on the “@ol-retailer” identifier. The documents 205 from “@deptstore” are grouped by the classifier into a base group or collection 215b based on the “@deptstore” identifier.

The documents 205 in the collection 215a are processed to group the documents 205 into base sub-groups or sub-collections of the collection 215a. The classifier groups the documents 205 originating from an “confirm@ol-retailer” account identifier into a sub-collection 220a. The classifier groups the documents 205 originating from a “status@ol-retailer” account identifier into a sub-collection 220b. The classifier groups the documents 205 originating from a “review@ol-retailer” account identifier into a sub-collection 220c.

Base sub-groups or sub-collections may be further subcategorized. For example, the sub-collection 220a includes documents 205, e.g., emails, pertaining to subject “X” and others pertaining to subject “Y”. As such, the classifier groups the documents 205 of the sub-collection 220a having a subject line of “Re:X” into a sub-collection 230a, and groups the documents 205 of the sub-collection 220a having a subject line of “Re:Y” into a sub-collection 230b.

The documents 205 included in the sub-collections 230a, 230b are then processed by one or more template generators, e.g., the template generators 120a-120n, to create a template 240a and a template 240b. The templates 240a and 240b are created by comparing the documents 205 in their corresponding sub-collections 240a, 240b to identify content and structure that is substantially common among the respective documents 205 and content and structure that differs. By identifying common and differing information among the documents 205, the templates 204a, 240b may be created to identify and extract information from the documents 205.

The template 240a may be used to process subsequently received documents 205 that are classified as belonging to the sub-category 230a, and the template 240b may be used to process subsequently received documents 205 that are classified as belonging to the sub-category 230b. In some implementations, the documents 205 may be processed to extract information that may be of interest or use to the recipients of the documents 205, and/or provide that information to the recipients.

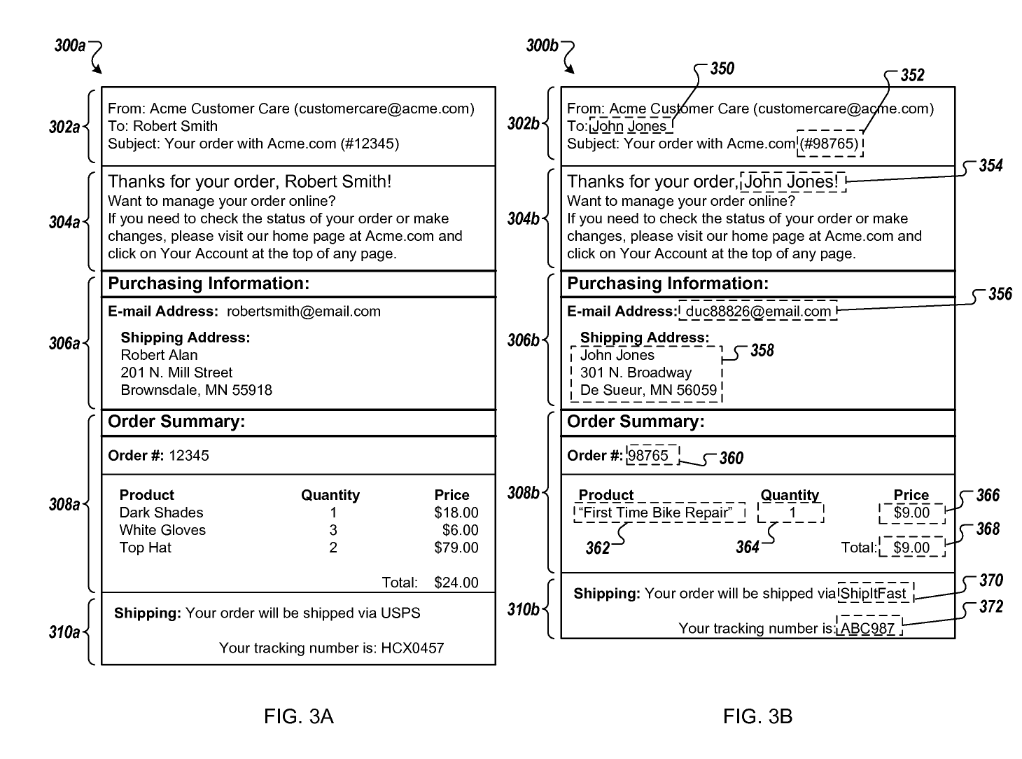

FIGS. 3A and 3B show examples of electronic documents that may be parsed for the automatic generation of templates. An example of an electronic document 300a, shown in FIG. 3A, and an example of an electronic document 300b, shown in FIG. 3B, are in the form of order confirmation emails from the address “customercare@acme.com” of the retailer “Acme.com”. In some implementations, the documents 300a and 300b can be two of the electronic documents 105 of FIG. 1.

Referring to FIG. 3A, the document 300a includes content sections such as an email header section 302a (e.g., including information such as sender email address, purchaser email address, email subject line), a “thank you” section 304a, a purchaser information section 306a (e.g., including the recipient's email address, shipping address), an order summary section 308a (e.g., including and order number, line item lists of items ordered), and a shipping section 310a (e.g., including shipper information, tracking identifiers).

Continuing with this example context, the retailer “Acme.com” sends out many such emails, e.g., for each order placed, which are a combination of common content such as section headers, boilerplate text, so-called “fine print”, and labels, and content that is generally specific to a particular order or purchaser such as recipient information and order details.

Such emails may also include a combination of common and specific metadata, layouts, structural elements, and other content that may be included in electronic documents. For example, the document 300a is formed with the sections 302a-310a arranged in a particular vertical order that may be detected by a template generator such as the template generators 120a-120n. In another example, the order summary section 308a may be laid out using HTML <table> tags, in which a common number of columns, e.g., “product”, “quantity”, “price”, are used across a variable number of rows, e.g., one per item ordered.

Referring now to FIG. 3B, the electronic document 300b represents an example of another order confirmation email provided by “Acme.com” in response to another order placed by another customer. In general, the document 300b includes an email header section 302b, a “thank you” section 304b, a purchaser information section 306b, an order summary section 308b, and a shipping section 310b. The sections 302b-310b are similar in content and layout to their counterparts 302a-310a, with exceptions that will be described next.

In addition to the content of the sections 302b-310b that is similar to the content of the sections 302a-310a, the document 300b also has elements that differ from other similar documents such as the document 300a. In the section 302b, a recipient name element 350 (e.g., John Jones) and an order number element 352 differ from the corresponding elements in the document 300a. In the section 304b, a recipient name element 354 (e.g., John Jones) differs from the corresponding name in the document 300a (e.g., Robert Smith). In the section 306b, a purchaser email address element 356 and a shipping address element 358 differ from the corresponding email and shipping addresses in the document 300a. In the section 310b, a shipper ID element 370 and an order tracking ID element 372 differ from the corresponding elements of the document 300a.

In the section 308b, and order number element 360, a product element 362, a quantity element 364, a price element 366, and a total price element 368 differ from corresponding elements in the document 300a. Additionally, the elements 362-366 all provide information relating to a single line item, which in this example is a book entitled “First Time Bike Repair”. Not only can the content of the elements 362-366 differ from document to document, but the number of repetitions of the elements 362-366 as a group may also differ. For example, the order summary section 308a can include three line items, while the order summary section 308b shows one line item. In examples such as this, template generators such as the template generators 120a-120n can recognize repeating or variable length elements, and treat them as such for purposes of template creation.

In some implementations, electronic document parsers such as the electronic document parser 140 can also recognize repeating or variable length elements for purposes of data extraction and/or document validation. For example, the electronic document parser 140 may apply a template that indicates predetermined minimum, maximum, or average number of line items that are expected for a selected section of an electronic document. For example, a template generated for the parsing of the electronic documents 300a and 300b may require that the number of line items in the order summary sections 308a, 308b include at least one, but no more than ten line items. An electronic document parser using such a template would then be able to identify the electronic document 300a (e.g., three line items) and the electronic document 300b (e.g., one line item) as having a valid number of line items. Another document having twelve line items, however, would be identified as being invalid for parsing by the selected template. In some implementations, the invalid electronic document may be provided for further processing, such as classifying the document as a candidate for further template generation.

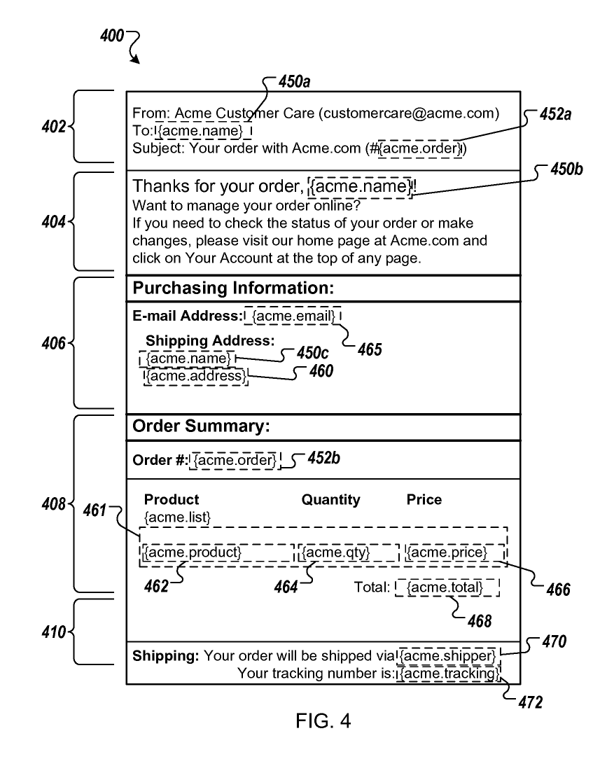

FIG. 4 shows a conceptual example of an automatically generated template 400 for parsing information from electronic documents. Continuing with the example context, the template 400 can be a template that is automatically generated by a comparison of a number of electronic documents having the same classification, such as the electronic documents 300a and 300b of FIGS. 3A and 3B.

The template 400 includes data that indicates the locations and contents of elements that are substantially shared across a collection of electronic documents such as the electronic documents 300a, 300b, and the locations and contents of elements that are substantially different across the collection of electronic documents. In the example of the template 400, an email header section 402 includes a recipient name marker 450a and an order number marker 452a. Content in the section 402 other than the markers 450a, 452a represents content that is expected to be substantially present in the corresponding classification of electronic documents.

In some implementations, content other than the markers in a selected section may be used to help identify the relative locations of elements for extraction from electronic documents. For example, content that is found immediately following the text “To:” in a processed electronic document may pertain to the recipient name marker 450a with relatively greater confidence than it may to markers located elsewhere. In another example, content that is found between the identified character sequences of “Acme.com (#” and “)” in a processed electronic document may pertain to the order number marker 452a with relatively greater confidence than it may to other markers located elsewhere.

A “thank you” section 404 includes a recipient name marker 450b to represent the relative location of content that is anticipated to differ among similarly classified documents, and other content that is anticipated to remain substantially unchanged among similarly classified documents. A purchaser information section 406 includes a recipient email address marker 465, a recipient name marker 450c, and a recipient address marker 460 to represent the relative locations of content that are anticipated to differ among similarly classified documents, and other content that is anticipated to remain substantially unchanged among similarly classified documents. A shipping section 410 includes a shipper identity marker 470 and an order tracking identifier marker 472 to represent the relative locations of content that are anticipated to differ among similarly classified documents, and other content that is anticipated to remain substantially unchanged among similarly classified documents.

An order summary section 408 includes an order number marker 452b, a product list marker 461, a product identifier marker 462, a product quantity marker 464, a product price marker 466, and a total price marker 468 to represent the relative locations of content that are anticipated to differ among similarly classified documents, and other content that is anticipated to remain substantially unchanged among similarly classified documents. In some implementations, a marker can represent multiple other markers or may represent a repeating collection of other markers. For example, the product list marker 461 can indicate that the product identifier marker 462, the product quantity marker 464, and the product price marker 466 may appear as a repeating group, e.g., a list of one or more line items in the example order email. In some implementations, a marker that represents a collection of markers may include metadata to indicate predetermined limits on the represented collection. For example, the marker 461 may indicate that the expected (e.g., average) number of items in a typical order is between one and ten items. In such an example, an electronic document parser such as the electronic document parser 140 of FIG. 1 may determine that a processed document includes an unexpected number of items (e.g., twenty) and identify the document as being invalid for the selected template.

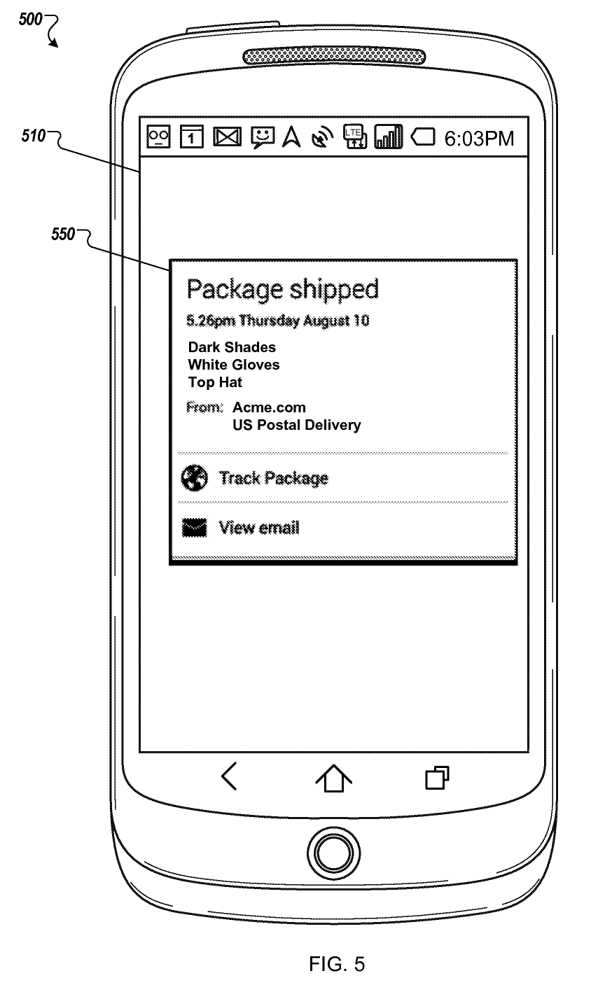

FIG. 5 depicts an example use case for data records provided in accordance with implementations of the present disclosure. A user device 500, e.g., a smart phone, tablet, portable computer, wearable computer, vehicle telematics system, presents information from a data record, such as the data record 160 of FIG. 1, to a user through the representation 510. In the illustrated example, the representation 510 presents information, based on a data record, about a package shipment, e.g., a shipment for the order described in the electronic document 300a. In some examples, in response to detecting that the order has been shipped, e.g., the user's inbox receives a shipping notification from a retailer, the device 500 can present at least some of the data from the corresponding data record in the representation 510.

Although implementations of the present disclosure are discussed above with reference to example identifiers, it is appreciated that implementations can be provided using any appropriate identifier. More specifically, implementations of the present disclosure are discussed above in view of FIGS. 2A-5 with reference to identifiers including email accounts, e.g., email addresses. It is contemplated, however, that other appropriate identifiers could be used. In addition to email addresses, example identifiers can include text provided in the subject line and/or in the body of an electronic document, e.g., in sections 302a, 302b and/or section 304a, 304b of FIGS. 3A and 3B. For example, electronic documents can be classified based on segmenting text of the subject line and/or body, where documents including the same or similar text can be grouped together.

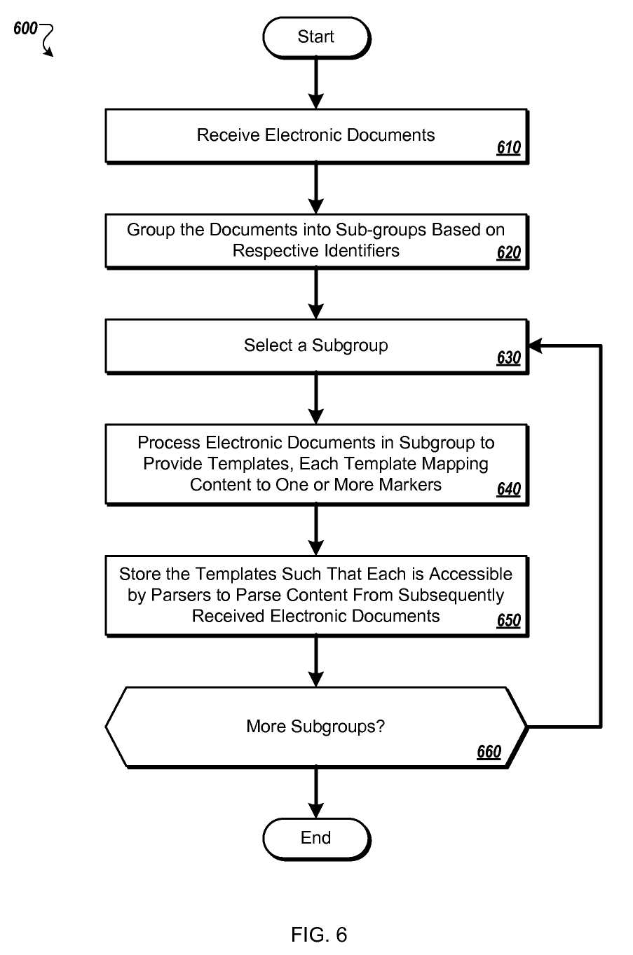

FIG. 6 is a flow diagram of an example of a process 600 that can be executed for the automatic generation of templates for parsing information from electronic documents. In some implementations, the process 600 may be performed by the system 100 of FIG. 1 to process the electronic documents 105 to create the templates 125a-125n.

A collection of electronic documents is received (610). Each electronic document is associated with an identifier. For example, the classifier 110 can receive the electronic documents 105. The electronic documents are grouped into a collection of base sub-groups based on respective identifiers (620). For example, the classifier 110 can group the electronic documents 105 into the collections 115a-115n, e.g., documents from “xyz.com” may be grouped into one of the collections 115a-115n and documents from “mno.com” may be grouped into another of the collections 115a-115n.

In some implementations, the identifier can be a network domain name for a sender of the associated electronic document, and the grouping can be determined at least in part according to a hierarchy of the network domain name. In some implementations, the plurality of electronic documents can be emails, and the identifier can be an email address of a sender of the associated electronic document, the email address having a local part and a domain part. In some implementations, the grouping can be determined at least in part according to the local part and the domain part. For example documents from “orders@xyz.com” may be grouped into one of the collections 115a-115n, where the identifier “orders@xyz.com” is an email address that includes the domain part “xyz.com” and the local part “orders@”. As such, documents from “returns@xyz.com” may be grouped into another of the collections 115a-115n.

For each base sub-group of the collection of base sub-groups, the electronic documents are automatically processed to provide one or more templates, each template mapping content to one or more markers. A subgroup is selected (630). The electronic documents in the selected subgroup are processed to provide a template that maps content to one or more markers (640). For example, the electronic documents 300a and 300b of FIGS. 3A and 3B can be processed by one of the template generators 120a-120n to create the template 400 of FIG. 4. The template includes the markers 450a-472 which indicate locations within electronic documents similar to the documents 300a-300b where content corresponding to the markers 450a-472 may be found.

In some implementations, automatically processing electronic documents to provide one or more templates can include identifying a first character string within a first electronic document of the collection of electronic documents, identifying a second character string within a second electronic document of the collection of electronic documents, aligning the first character string and second character string, comparing the first character string to the second character string, identifying, based on the comparing, at least one of a shared substring section comprising a sequence a characters that are substantially similar between the first character string and the second character string, and a difference substring comprising a sequence of characters that are substantially different between the first character string and the second character string, identifying one of the markers to represent information provided by the electronic document at a location of the difference substring, providing the marker and the location of the difference substring as the template, and associating the template with one or more of the plurality of base sub-groups. For example, a first electronic document may include the character string “your table for six has been reserved” and a second electronic document may include the character string “your table for two has been reserved”. The two strings may be compared to determine an alignment between the two. For example, both strings include “your table for” and “has been reserved”, and the two strings can be aligned such that the differences between the strings can be minimized, e.g., only the “six” and “two” substrings differ. With the strings aligned, the strings can be compared to identify the locations of substrings that may differ, e.g., the relative location where “six” and “two” occur within the strings. In some implementations, substrings that differ may determine as including content that may be extracted for use in a data record. For example, the recipient of the electronic document including the first string may receive the output of a data record that reflects a dinner reservation for six, while the recipient of the electronic document including the second string may receive the output of a data record that reflects a dinner reservation for two.

In some implementations, one or more of the markers may represent a line item that includes at least one sub-marker. For example, the product list marker 461 represents a collection of markers including the product identifier marker 462, the product quantity marker 464, and the product price marker 466. In some implementations, the one or more markers can represent a collection of line items. For example, the product list marker 461 represents a collection order line items in which each line item includes a corresponding one of the product identifier marker 462, the product quantity marker 464, and the product price marker 466.

In some implementations, a quantity of line items in the collection of line items may be determined by determining that the quantity satisfies at least one predetermined threshold and associating the plurality of line items with a marker to represent the plurality of line items. For example, the template 400 includes the product list marker 461, and during generation of the template 400 a predetermined threshold limit on the number of items (e.g., one, five, ten, twenty, or any other appropriate number) that are expected to be encountered in subsequent electronic documents may be associated with a marker such as the product list marker 461. In some implementations, the threshold may be based on an expected average number of line items in an electronic document. When appropriate documents are processed using the template 400, if a number of items in a product list is determined to be within the threshold, then the items in that list may be extracted as a collection of items associated with the product list marker 461. If the number is outside the threshold, then the document may be flagged as being invalid to be processed using the template 400.

The templates are stored such that each template is accessible by one or more parsers to parse content from subsequently received electronic documents (650). For example, the templates 125a-125n can be stored by the data repository 130, and the stored templates can be accessed by the electronic document parser 140 to parse content from additional ones of the electronic documents 105. If it is determined that additional subgroups remain to be processed (660), then another subgroup is selected (630). If it is determined that no additional subgroups remain to be processed (660), then the process 600 ends or returns to another process from which the process 600 was called.

Implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer can include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any implementation of the present disclosure or of what may be claimed, but rather as descriptions of features specific to example implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving a set of electronic documents;
for each electronic document in the set of electronic documents, classifying the document as belonging to a respective one subset of electronic documents from among multiple candidate subsets of electronic documents;
for each electronic document in a particular subset of electronic documents, annotating, using a template generator, one or more portions of the electronic document as likely static content and one or more portions of the electronic document as likely dynamic content, based at least on an analysis of respective positions of nodes that represent the one or more portions of the electronic document that are annotated as likely static content and respective positions of nodes that represent the one or more portions of the electronic document that are annotated as likely dynamic content in a node-based structure of a hierarchical representation of the electronic document;
generating a template for the particular subset based on the annotated electronic documents of the particular subset;
applying the template to a particular electronic document of the particular subset of electronic documents to generate a data record; and
providing, for output, a user interface that presents information based on the generated data record.

2-23. (canceled)

24. The method of claim 1, wherein annotating, using a template generator that is specific to the particular subset, one or more portions of the electronic document as likely static content and one or more portions of the electronic document as likely dynamic content comprises:
providing an analysis corresponding to the respective positions of nodes that represent the one or more portions of the electronic document as likely static content; and
based at least in part on the analysis, determining the one or more portions of the electronic document as likely dynamic content.

25. (canceled)

26. The method of claim 1, wherein generating the template for the particular subset based on the annotated electronic documents of the particular subset further comprises:
providing a comparison between a subset of annotations of the annotated electronic documents of the particular subset; and
generating the template for the particular subset based on the comparison.

27. The method of claim 1, wherein the one or more portions of the electronic document as likely static content and the one or more portions of the electronic document as likely dynamic content represent a plurality of line items.

28. The method of claim 27, further comprising:
determining that the plurality of line items satisfies a predetermined threshold indicating an expected average number of line items in the electronic document; and
associating the plurality of line items with a marker.

29. The method of claim 1, further comprising:
in response to applying the template to a particular electronic document of the particular subset of electronic documents to generate a data record, determining one or more actions based on the generated data record; and
causing the one or more actions to be performed.

30. The method of claim 1, wherein applying the template to a particular electronic document of the particular subset of electronic documents to generate a data record further comprises providing one or more metrics based on the generated data record.

31. A system comprising:
a data store for storing data; and
one or more processors configured to interact with the data store, the one or more processors being further configured to perform operations comprising:
receiving a set of electronic documents;
for each electronic document in the set of electronic documents, classifying the document as belonging to a respective one subset of electronic documents from among multiple candidate subsets of electronic documents;
for each electronic document in a particular subset of electronic documents, annotating, using a template generator, one or more portions of the electronic document as likely static content and one or more portions of the electronic document as likely dynamic content, based at least on an analysis of respective positions of nodes that represent the one or more portions of the electronic document that are annotated as likely static content and respective positions of nodes that represent the one or more portions of the electronic document that are annotated as likely dynamic content in a node-based structure of a hierarchical representation of the electronic document;
generating a template for the particular subset based on the annotated electronic documents of the particular subset;
applying the template to a particular electronic document of the particular subset of electronic documents to generate a data record; and
providing, for output, a user interface that presents information based on the generated data record.

32. The system of claim 31, wherein annotating, using a template generator that is specific to the particular subset, one or more portions of the electronic document as likely static content and one or more portions of the electronic document as likely dynamic content comprises:
providing an analysis corresponding to the respective positions of nodes that represent the one or more portions of the electronic document as likely static content; and
based at least in part on the analysis, determining the one or more portions of the electronic document as likely dynamic content.

33. (canceled)

34. The system of claim 31, wherein generating the template for the particular subset based on the annotated electronic documents of the particular subset further comprises:
providing a comparison between a subset of annotations of the annotated electronic documents of the particular subset; and
generating the template for the particular subset based on the comparison.

35. The system of claim 31, wherein the one or more portions of the electronic document as likely static content and the one or more portions of the electronic document as likely dynamic content represent a plurality of line items.

36. The method of claim 35, further comprising:
determining that the plurality of line items satisfies a predetermined threshold indicating an expected average number of line items in the electronic document; and
associating the plurality of line items with a marker.

37. The system of claim 31, further comprising:
in response to applying the template to a particular electronic document of the particular subset of electronic documents to generate a data record, determining one or more actions based on the generated data record; and
causing the one or more actions to be performed.

38. The system of claim 31, wherein applying the template to a particular electronic document of the particular subset of electronic documents to generate a data record further comprises providing one or more metrics based on the generated data record.

39. A non-transitory computer-readable storage medium encoded with executable instructions that, when executed by at least one processor, cause the at least one processor to perform operations comprising:
receiving a set of electronic documents;
for each electronic document in the set of electronic documents, classifying the document as belonging to a respective one subset of electronic documents from among multiple candidate subsets of electronic documents;
for each electronic document in a particular subset of electronic documents, annotating, using a template generator, one or more portions of the electronic document as likely static content and one or more portions of the electronic document as likely dynamic content, based at least on an analysis of respective positions of nodes that represent the one or more portions of the electronic document that are annotated as likely static content and respective positions of nodes that represent the one or more portions of the electronic document that are annotated as likely dynamic content in a node-based structure of a hierarchical representation of the electronic document;
generating a template for the particular subset based on the annotated electronic documents of the particular subset;
applying the template to a particular electronic document of the particular subset of electronic documents to generate a data record; and
providing, for output, a user interface that presents information based on the generated data record.

40. The computer-readable medium of claim 39, wherein annotating, using a template generator, one or more portions of the electronic document as likely static content and one or more portions of the electronic document as likely dynamic content comprises:
providing an analysis corresponding to the respective positions of nodes that represent the one or more portions of the electronic document as likely static content; and
based at least in part on the analysis, determining the one or more portions of the electronic document as likely dynamic content.

41. (canceled)

42. The computer-readable medium of claim 39, wherein generating the template for the particular subset based on the annotated electronic documents of the particular subset further comprises:
providing a comparison between a subset of annotations of the annotated electronic documents of the particular subset; and
generating the template for the particular subset based on the comparison.

43. The computer-readable medium of claim 39, wherein the one or more portions of the electronic document as likely static content and the one or more portions of the electronic document as likely dynamic content represent a plurality of line items.

44. (canceled)

45. (canceled)

46. The method of claim 1, wherein generating the template for the particular subset based on the annotated electronic documents of the particular subset comprises:
providing a comparison between the respective positions of nodes that represent the one or more portions of the electronic document that are annotated as likely static content and the respective positions of nodes that represent the one or more portions of the electronic document that are annotated as likely dynamic content of the annotated electronic documents of the particular subset; and
generating the template for the particular subset based on the comparison between the respective positions of nodes that represent the one or more portions of the electronic document that are annotated as likely static content and the respective positions of nodes that represent the one or more portions of the electronic document that are annotated as likely dynamic content of the annotated electronic documents of the particular subset.

47. The method of claim 1, wherein generating the template for the particular subset based on the annotated electronic documents of the particular subset comprises:
for each electronic document in the particular subset of electronic documents, analyzing the node-based structure of a hierarchical representation of the electronic document to identify a root node that represents a common portion of the electronic document between the annotated electronic documents of the particular subset;
for each electronic document in the particular subset of electronic documents, determining that the root node includes a quantity of leaf nodes that are each separated by edges from the root node; and
generating the template for the particular subset based on (i) the root node and (ii) the quantity of leaf nodes that are each separated by edges from the root node.
